(19) United States
(12) Patent Application Publication
(10) Pub. No.: US 2005/0097697 A1
(43) Pub. Date: May 12, 2005

(54) Moon trowel

(76) Inventor: Mario Nistico, Stuyvesant, NY (US)

Correspondence Address: ARLEN L. OLSEN;SCHMEISER, OLSEN & WATTS, 3 LEAR JET LANE, SUITE 201, LATHAM, NY, 12110, US

(21) Appl. No.: 11/015,802

(22) Filed: Dec. 17, 2004

Related U.S. Application Data
(62) Division of application No. 10/268,389, filed on Oct. 10, 2002.

(51) Int. Cl. B05C 17/10

(52) U.S. Cl. 15/235.4; 15/236.01; D08/45; D32/46

(57) ABSTRACT

The Moon Trowel is a tool of convenience. Because of the unique design and shape of the blade, anyone who uses it will not want to be without it. Its convex shaped blade matches perfectly with the inside of a five gallon bucket enabling the user to efficiently retrieve all materials, whatever they may be, from the inside of the bucket with little waste or effort. The idea is simple, match the shape of the trowel blade to the inside shape of the five gallon bucket which comes out to be a curve of 5⅝″ radius. A perfect fit means no manipulation of the tool to get it to work properly. Tools should not have to be manipulated to work . . . they should just work. The Moon Trowel works extremely well.

### BACKGROUND OF THE INVENTION

The Moon Trowel will be a useful and efficient tool to anyone involved in the construction field.

It retrieves material such as joint compound for sheetrock (tapers trade), cement or mortar including thin-set mortar for ceramic tile ( masonry and laborers trade) and tar (roofers trade)out of five gallon buckets with absolutely zero waste. All the material inside the bucket is efficiently retrieved. Five gallon buckets are the most commonly used because they are so abundant and are just the right size for handling and transporting materials from one place to another.

Pesently, and prior to my invention, the only tool available to get materials out of a five gallon bucket is any trowel with a straight edged blade. Using a straight edged tool to get something out of a round bucket is awkward, time consuming, and wasteful.

The marketing of the Moon Trowel will save contractors and do-it-yourselfers time and money.

### BRIEF SUMMARY OF THE INVENTION

Prior to my invention, anyone wishing to get materials such as joint compound, mortar or cement, thin set mortar, or tar out of a five gallon bucket, would have to settle to use a trowel with a straight blade.

Because the inside of a five gallon bucket is curved (5⅝″ radius) the straight blade trowel would have to be manipulated in a manner as to retrieve the material, thus some of the material would fall off the trowel and remain in the bucket.

The Moon Trowel cures this. Its blade is shaped to the exact contour of the inside of the bucket.

### BRIEF DESCRIPTION OF THE SEVERAL VIEWS OF THE DRAWING

FIG. 1 shows the Moon Trowel front view. This view consists of a blade with attached handle. The blade end is convexed shaped, curved to 5⅝″ radius. The blade is six inches wide. The handle is four inches long.

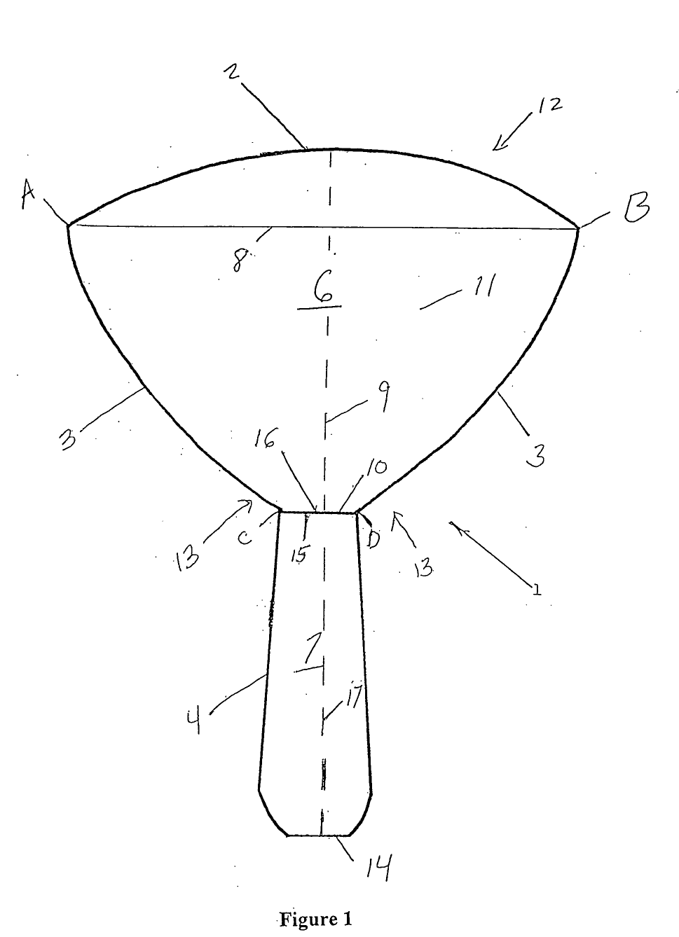

FIG. 2 shows the Moon Trowel side view. The blade is four inches from the top of the handle to the top of the curve of the blade. The total length is eight inches. The handle is ¾ of an inch thick.

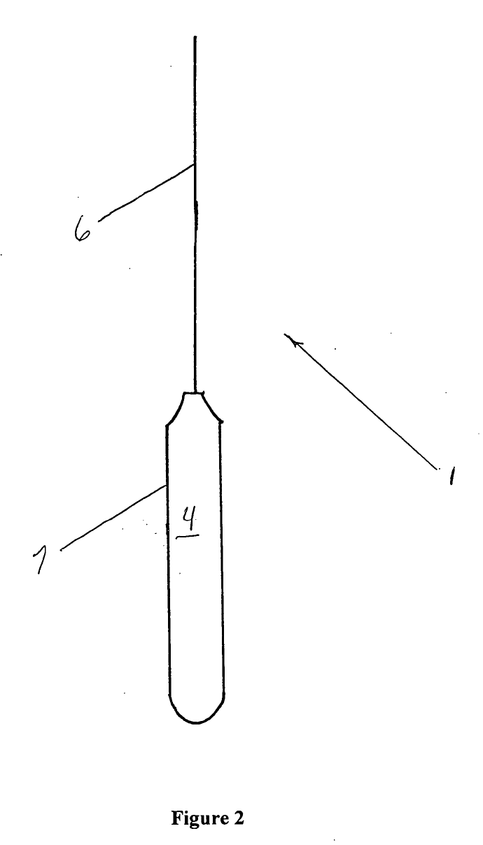

### DETAILED DESCRIPTION OF THE INVENTION

The Moon Trowel is a very simple tool. Simple to both use and make. To use it, grasp the tool by the handle and use it to retrieve whatever material you need to get out of a five gallon bucket. The blade is shaped to meet and match the inside walls of a five gallon bucket. When retrieving materials with the Moon Trowel, you press the blade of the trowel against the inside of the bucket and using an upward motion, scrape the walls of the bucket clean. By the time the materials are used up, the Moon Trowel will have scraped out ALL (100%) of the material from the inside of the bucket.

The making of the Moon Trowel is just as easy as using it. To make or manufacture it, all you need to do is design a concave shaped die in which you stamp out a convex shaped blade. The die in this case will have a concave curve of 5⅝″ radius. When the die stamps the blade, you are left with a convex shaped blade consisting of the same 5⅝″ radius curve.

In the past and present, anyone wishing to get materials out of a five gallon bucket has to settle for a trowel with a straight blade. This would be ideal if materials came in square five gallon buckets with flat straight sides, but they don't. They come in round five gallon buckets with curved sides.

The specific improvement is really the shape of the blade.

1. (canceled).

2. A method, comprising:
providing a container having spread able materials therein;
providing a trowel, comprising:
a blade, wherein the blade has a planar surface, wherein a first portion of a perimeter of the blade has a first convex shaped edge, wherein the first convex shaped edge has a first and a second end, and wherein a first transverse line connecting the ends of the first convex shaped edge is orthogonal to a longitudinal axis of the blade;
a handle, extending from a second portion of the perimeter of the blade, wherein the handle has a proximal end that is closest to the second portion of the perimeter of the blade and a distal end that is farthest from the second portion of the perimeter of the blade, wherein a second transverse line having first and second ends is coplanar with the proximal end of the handle and parallel to the first transverse line, wherein a longitudinal axis of the handle is coplanar with the longitudinal axis of the blade; and wherein sides of the blade form a relatively smooth convex curve between respective ends of the first convex shaped edge and the second transverse line; and
retrieving the materials with the trowel.

3. The method of claim 2, wherein the spread able materials include one of tar, cement, mortar and joint compound.

4. The method of claim 2, wherein retrieving the materials includes pressing the blade of the trowel against the inside of the container and applying an upward motion.

5. The method of claim 2, wherein the container has a 5 gallon volume.

6. The method of claim 2, wherein retrieving the materials includes scraping a wall of the container with the first convex shaped edge of the first portion of the perimeter of the blade.

7. The method of claim 6, wherein retrieving the materials by scraping results in retrieving essentially all of the materials in the container.

8. The method of claim 2, wherein retrieving the materials includes pressing the first convex shaped edge of the first portion of the perimeter of the blade against the container and using an upward motion.

9. The method of claim 2, wherein retrieving the materials includes matching the first convex shaped edge of the first portion of the perimeter of the blade to an inside shape of the container.

10. The method of claim 9, wherein essentially all of the material is retrieved when the first convex shaped edge of the first portion of the perimeter of the blade matches the shape of the container.

11. The method of claim 2, wherein the container has a 5⅝ inch radius of curvature.
